(19) United States
(12) Patent Application Publication
(10) Pub. No.: US 2026/0194080 A1
(43) Pub. Date: Jul. 9, 2026

(54) TWO-WAY QUICK CYLINDER AND WOOD SPLITTER

(71) Applicants: Lixin WANG, Zhejiang (CN); ZHEJIANG GREATBULL INDUSTRY & TRADE CO., LTD., Zhejiang (CN)

(72) Inventor: Lixin WANG, Zhejiang (CN)

(21) Appl. No.: 19/023,488

(22) Filed: Jan. 16, 2025

Related U.S. Application Data
(63) Continuation of application No. PCT/CN2025/070644, filed on Jan. 6, 2025.

(51) Int. Cl. F15B 15/14; B27L 7/06

(52) U.S. Cl. CPC F15B 15/1428; B27L 7/06; F15B 15/1447; F15B 15/1476; F15B 2211/20507; F15B 2215/30

(57) ABSTRACT

The present technical solution belongs to the technical field of wood splitting devices, and specifically relates to a two-way quick cylinder and wood splitter, including a hydraulic oil cylinder body; a large piston, which is slidably provided in the hydraulic oil cylinder body and divides the inner chamber of the hydraulic oil cylinder body into a rod chamber and a rodless chamber; a piston rod, which is telescopically installed on the hydraulic oil cylinder body, and the end of the said piston rod extends into the rod chamber to be connected with the large piston; a hydraulically controlled one-way valve, which is installed on the large piston to be automatically opened and closed depending on different working conditions of the two-way quick cylinder when the piston rod performs the reciprocating movement operation, making the hydraulic oil in the rod chamber and the rodless chamber compensated each other.

### CROSS-REFERENCE TO RELATED APPLICATIONS

The present application is a continuation of International Application No. PCT/CN2025/070644, with an international filing date of Jan. 6, 2025, the entire contents of all of which are incorporated herein by reference.

### TECHNICAL FIELD

The present technical solution relates to the technical field of log splitting devices, particularly to a two-way quick cylinder and wood splitter.

### BACKGROUND

As important auxiliary equipment in the wood processing industry, the existing wood splitters are mainly divided into the vertical and horizontal series. The core function is that, they apply hydraulic principles to split hard woods such as stumps, large branches and log segments, thereby meeting the specific size requirements or converting them into materials for other uses.

When splitting wood, the wood splitter needs the cylinder to provide huge thrust, and meanwhile the cylinder can be quickly extended in the non-splitting stage or retracted after the wood is split, so as to improve the working efficiency. Therefore, some larger wood splitters use a tandem pump design to achieve this function. The tandem pump is composed of a low-pressure large pump and a high-pressure small pump in parallel. When the wood splitter does not need to split wood vigorously, the large pump and the small pump will supply oil at the same time, working in a large-flow and low-pressure mode, making the cylinder achieve a faster speed under a smaller thrust; and when a large thrust is required, the hydraulic oil in the large pump will flow back to the oil tank, ensuring that the engine power is sufficient to meet the high-pressure working requirements of the small pump.

However, with respect to the related technology mentioned as above, the inventor thinks that the existing wood splitters still have the following deficiencies:
1. When the tandem pump is used in a working condition with uneven load, since the large pump is always running in the working condition with high pressure, the hydraulic oil pumped into the cylinder does not play a practical role, and all the work is in vain. In addition, the co-working of the large pump and the small pump requires the entire hydraulic system to be equipped with a larger hydraulic oil tank, and the system has a relatively serious heating problem.
2. In the existing wood splitter, the guide rail on the main beam is directly connected to the front baffle, and holes are opened at the front end of the main beam for removing wood chips. Such practice not only affects the structural strength of the main beam, but also makes the cleaning work extremely difficult because the broken wood needs to be discharged through these holes. At the same time, the effect of discharging the wood chips through the holes is not ideal, and not all the residual wood chips can be effectively removed.
3. The front baffle and the tail plate for the main beam of the wood splitter are made of thick steel plates, which makes the entire wood splitter cumbersome, and the bending strength of the front baffle is not sufficiently guaranteed, resulting in insufficient strength. At the same time, the use of thicker steel plates also increases the manufacturing cost of the wood splitter, which has an adverse effect on the production efficiency and the cost control.

### SUMMARY

The present technical solution is to provide a two-way quick cylinder and wood splitter. By providing a hydraulically controlled one-way valve on the large piston of the two-way quick cylinder, hydraulic oil in the rod chamber can enter the rodless chamber when the two-way quick cylinder is in the light-load or no-load working conditions, so that only a small pumping flow rate is required to achieve quick extension of the piston rod, thereby solving the problem of low efficiency and high energy consumption of the hydraulic system caused by a huge working flow and a great energy loss in the existing design.

Furthermore, the wood splitter of the present technical solution adopts a two-way quick cylinder, which only requires a small amount of power and hydraulic system flow to operate, so that the system only needs a smaller oil tank and a mating integrated power unit. Secondly, the present technical solution improves and partially strengthens the main beam of the wood splitter and the structural shape of the wood splitting axe, ensuring that they can better cooperate with the efficient operation of the two-way quick cylinder, thereby improving the overall wood splitting performance and efficiency.

The purpose of the present technical solution is so achieved that:
A two-way quick cylinder, comprises: a hydraulic oil cylinder body; a large piston, which is slidably provided in the said hydraulic oil cylinder body and divides the inner chamber of the said hydraulic oil cylinder body into a rod chamber and a rodless chamber; a piston rod, which is telescopically installed on the said hydraulic oil cylinder body, and the end of the said piston rod extends into the said rod chamber to be connected with the said large piston; a hydraulically controlled one-way valve, which is installed on the said large piston to be used for communicating the said rod chamber and the said rodless chamber; and when hydraulic oil enters the rodless chamber from the oil pump and drives the large piston to move, the oil pressure in the said rod chamber increases and the hydraulically controlled one-way valve is enabled to open, so that the hydraulic oil in the rod chamber enters the rodless chamber through the hydraulically controlled one-way valve and pushes the large piston to move.

Preferably, it also comprises: an elastic member, one end of which is movably connected to the piston rod extending out of the said hydraulic oil cylinder body, the other end is movably connected to the said hydraulic oil cylinder body, and the said elastic member makes the said piston rod have a movement trend to retract into the hydraulic oil cylinder body; the said rod chamber is provided with a fourth through hole communicating the inner and outer sides thereof, and the rodless chamber is provided with a fifth through hole communicating the inner and outer sides thereof; when the elastic member causes the piston rod to displace, the said large piston moves to make the hydraulic oil in the rodless chamber flow out from the fifth through hole, and the oil pump delivers hydraulic oil into the rod chamber; or it also comprises: a quick reset unit, which is used to control the hydraulic oil in the rodless chamber to return to the rod chamber through the said hydraulically controlled one-way valve; the quick reset unit comprises a hollow perforated inner pull rod, a small piston, a push rod seat and a push rod assembly; the said piston rod is hollow; one end of the said hollow perforated inner pull rod is connected to the cylinder rear cover of the said hydraulic oil cylinder body, the other end passes through the said large piston and extends into the inner chamber of the said piston rod, and the said hollow perforated inner pull rod is slidably connected to the said large piston; the said large piston is provided with a mounting chamber, in which a push rod seat and a push rod assembly are provided; an oil passage communicating the said rod chamber and the hydraulically controlled one-way valve is formed in the middle of the push rod seat and the push rod assembly; the part of the said push rod seat adjacent to the said hydraulically controlled one-way valve is a guide portion II, and an auxiliary piston chamber is formed between the peripheral side of the guide portion II and the side wall of the mounting chamber, one end of the said push rod assembly is provided in the said auxiliary piston chamber to form a piston portion, and the other end of the push rod assembly faces the said hydraulically controlled one-way valve; the said small piston is connected to one end of the said hollow perforated inner pull rod, the peripheral side of the said small piston is slidably connected to the inner chamber wall of the said piston rod, and the said small piston divides the inner chamber of the said piston rod into a reset area and an avoidance area; the said reset area is communicated to the oil circuit inside the hollow perforated inner pull rod; a control oil hole is provided on the said piston rod, the control oil hole is communicated to the said reset area, and the control oil hole makes the oil circuit between the said reset area and the said auxiliary piston chamber communicated; and when hydraulic oil in the reset area enters the auxiliary piston chamber, the push rod assembly drives the said hydraulically controlled one-way valve to open.

Preferably, a control unit is provided on the said hydraulic oil cylinder body, and the said control unit comprises a control valve; and the said control valve is in plate connection with the cylinder front cover of the said hydraulic oil cylinder body, the said control valve and the said cylinder rear cover are communicated through two connecting oil pipes, and the said control valve is used to control the said connecting oil pipes to supply oil to the said rodless chamber or the said reset area respectively.

Preferably, the said hydraulically controlled one-way valve comprises a first steel ball and a first spring; a first through hole is opened on the said large piston, and the said rodless chamber is communicated with the said rod chamber through the said first through hole; and one end of the said first spring is connected to the said large piston, and the other end is connected to the said first steel ball, making the said first steel ball block the said first through hole.

Preferably, a hydraulically controlled switching valve is integrated on the said control unit or the cylinder front cover, and when hydraulic oil pressure in the said rodless chamber reaches a set value P, the said hydraulically controlled switching valve makes the said rod chamber communicate with the oil return line; a second through hole is provided on the said cylinder front cover, and the said rod chamber and the oil return line are communicated through the said second through hole; an oil circuit board is connected to the said control valve, the said oil circuit board is mounted on the said cylinder front cover, a third through hole is provided on the said oil circuit board, and the oil return line and the second through hole are communicated through the third through hole; the said hydraulically controlled switching valve comprises: a thrust controlled push rod valve core, a second steel ball and a second spring; one end of the said second spring is connected to the said oil circuit board, and the other end is connected to the said second steel ball, making the said second steel ball block the said third through hole; and the said thrust controlled push rod valve core is slidably connected in the said oil circuit board, and the push rod of the said thrust controlled push rod valve core can pass through the said third through hole to abut against the said second steel ball.

Preferably, the said hydraulic oil cylinder body comprises a cylinder body, a cylinder front cover installed on the cylinder body, a cover and a control valve in plate connection with the cylinder front cover; and the said cylinder body comprises a cylinder steel pipe and a cylinder rear cover, wherein the cylinder steel pipe, the cylinder rear cover and two connecting oil pipes are welded into a whole, the cylinder rear cover is provided with an ejection oil hole communicating the rodless chamber and the control valve as well as a retraction oil hole communicating the hollow perforated inner pull rod and the control valve, and the two connecting oil pipes are inserted into the said control valve.

A wood splitter, comprises a frame, a baffle, a wood splitting axe, the said two-way quick cylinder and a power unit; the two-way quick cylinder is installed on the said frame, the baffle is installed on the said frame, the wood splitting axe is installed on the driving end of the two-way quick cylinder, and a working space for placing wood is formed among the frame, the baffle and the wood splitting axe; the power unit is installed on the said frame to provide power for the two-way quick cylinder; among them, the said frame is provided a main beam, the base of the main beam is made of H-shaped steel, the tail end of the said main beam is bent and warped upwards, the tail end of the said main beam is inlaid and welded with a tail plate, reinforcing plates are provided on both sides of the said tail plate, and the ends of the two-way quick cylinder are installed on the reinforcing plates and the tail plate; reinforcing rib plates are provided on both sides of the said main beam, the upper ends of the reinforcing rib plates are bent and placed above the main beam to form guide rails for the wood splitting axe to slide; and guide plates are provided obliquely on both sides of the main beam, the said guide plates are located between the guide rails and the baffle, and the guide plates are used for guiding the wood chips to fall from the upper end of the main beam.

Preferably, the said power unit comprises an engine, an adapter plate, an oil pump and an oil tank; the oil pump is provided in the oil tank and integrated with the engine through the adapter plate; the said engine is connected to the said frame; one side of the said adapter plate is connected to the said engine, and the other side is connected to the said oil pump; the oil tank is provided on the outer peripheral side of the said oil pump in a housing manner, and the said oil tank is connected to the said adapter plate; and the oil pump is connected to the said control unit through the adapter plate and the oil pipeline successively, and delivers hydraulic oil to the said reset area or the said rodless chamber respectively through the control unit.

Preferably, the side of the baffle away from the wood splitting axe is provided with a plurality of reinforcing ribs, the plurality of reinforcing ribs are connected end to end and welded to form reinforcing rings, and the inner walls of the said reinforcing rings are welded through the reinforcing ribs; and the side of the baffle close to the wood splitting axe is provided with a plurality of fixing protrusions, which are used to fix the ends of the wood.

Preferably, the wood splitting axe is in an S-type eagle head shape. It comprises a force-bearing main body, a guide portion I and a blade portion; the guide portion I is located at the lower side of the force-bearing main body and the blade portion and is provided horizontally, the force-bearing main body is provided vertically above the guide portion I, the blade portion is provided on the side of the force-bearing main body away from the two-way quick cylinder, and the front end of the blade portion is provided with a cutting edge; a fixing portion is arranged on the upper side of the said cutting edge, and the fixing portion is used to fix the wood; the lower half of the said cutting edge is provided with a knife edge portion in a protruding manner, and the knife edge portion is used to split the wood; the said fixing portion is farther away from the said two-way quick cylinder than the knife edge portion; an arc-shaped concave first blade portion is formed between the fixing portion and the knife edge portion; and an inwardly inclined second blade portion is formed on the lower side of the knife edge portion.

Preferably, the hydraulic power for the wood splitter is a highly integrated power unit, with the oil pump located in a small oil tank to be integrated with the engine or motor.

Compared with the prior art, the present technical solution has the following outstanding and beneficial technical effects that:
1. The hydraulically controlled one-way valve designed in the present technical solution enables hydraulic oil in the rod chamber of the two-way quick cylinder to enter the rodless chamber when the cylinder is used in light-load or no-load working conditions, so that the piston rod can be pushed out quickly with a smaller pump-in flow rate. This not only reduces the energy consumption of the hydraulic system, achieves environmental protection and energy saving, and reduces the total demand for hydraulic oil and the delivery and control costs of hydraulic oil, thereby reducing the manufacturing cost and use cost of the product; and in addition, the highly integrated design of the two-way quick cylinder has a simple structure and is easy to operate, which reduces the manufacturing cost.
2. In the present technical solution, the hydraulically controlled switching valve is designed on the control valve. The hydraulically controlled switching valve can be automatically opened or closed with the load changes of the two-way quick cylinder, realizing automatic switching between light-load quick and heavy-load slow working conditions, solving the problem of contradiction among thrust, speed and power during uneven load operation, achieving heavy-load operation through a simple structure, and avoiding the problems of high energy consumption and high cost caused by complex hydraulic systems such as tandem pumps, etc.
3. In the present technical solution, a working space is formed for placing wood among the frame, the baffle and the wood splitting axe; the power unit provides power for the two-way quick cylinder; the hydraulically controlled one-way valve drives the piston rod to operate quickly in both directions with a smaller hydraulic oil pump-in flow, thereby reducing the idle (waiting) time during operation of the wood splitter and improving the working efficiency. Therefore the power of the wood splitter is reduced but the working efficiency is improved, which reduces the manufacturing cost, use cost and maintenance cost.
4. The hydraulic oil cylinder body of the present technical solution comprises a cylinder body, a cylinder front cover installed on the cylinder body, a cylinder rear cover, two connecting oil pipes, a threaded cover and a control valve; the cylinder steel pipe of the cylinder body is welded with the cylinder rear cover and the two connecting oil pipes into a whole, and the connecting oil pipes are directly inserted into the control valve for installation, which simplifies the installation of the oil pipe joint and reflects the characteristics of overall integration; and meanwhile, the control valve and the cylinder front cover are in plate connection, which is easy to install and simple to operate, avoiding the cumbersome installation problem for the oil pipe joint and the control valve.
5. The power unit of the wood splitter in the present technical solution is highly integrated, and the oil pump is located in a smaller oil tank to be integrated with the engine or motor, so that the number of oil pipes can be reduced, and the oil leakage at the oil pipe connections can be avoided; and meanwhile, the present technical solution can reduce the volume of the oil tank due to the small hydraulic oil flow required by the hydraulic system, and through the design of the adapter plate, the connecting oil pipes of the existing wood splitter are eliminated, so that the occurrence of failures due to oil leakage can be reduced. In addition, because the power of the wood splitter has no direct correlation and restriction relationship with the thrust and speed, the power unit of the present technical solution can be adapted to wood splitters of various specifications and sizes, thereby saving the manufacturing and management costs.
6. The main beam of the frame in the present technical solution is H-shaped steel, the tail end of the main beam is bent and warped upwards as well as inlaid and welded with a tail plate, and the ends of the two-way quick cylinder are installed on the reinforcing plates and the tail plate; and compared with the existing wood splitters that are all welded by steel plates, the connection strength is improved, the manufacturing cost is reduced, and the coordination and beauty of the whole machine is still maintained through the overall cutting and forming of profiles.
7. The main beam of the present technical solution is provided with guide rails for the wood splitting axe to slide. The guide rails are formed by bending the upper ends of the reinforcing rib plates, and are placed above the main beam. Compared with the existing wood splitter that uses two long steel plates stacked together, the manufacturing cost is reduced.
8. In the present technical solution, guide plates are provided between the guide rails and the baffle. The guide plates can be used for positioning the wood together with the guide rails, and can also be used to guide the falling of wood chips.
9. The wood splitting axe of the present technical solution is in an S-type eagle head shape, and the eagle head shape can be used to better split the wood; the eagle's beak forms a fixing portion to be used for fixing the wood, and the first blade portion corresponding to the concave part of the eagle's beak pulls the wood downwards to split; and particularly in the process of splitting the wood, the knife edge portion corresponding to the protruding part under the eagle's beak is located at the lower edge of the wood, which is more conducive to splitting the wood.
10. The baffle on the front end of the main beam in the present technical solution is provided with a plurality of reinforcing ribs, the reinforcing ribs are connected end to end to form reinforcing rings, and the inner walls of the reinforcing rings are welded through the reinforcing ribs, thereby increasing the deformation resistance of the baffle.

### BRIEF DESCRIPTION OF THE DRAWINGS

FIG. 1 is a schematic diagram for the structure of the present technical solution.

FIG. 2 is side view of the present technical solution.

FIG. 3 is a schematic diagram for the structure of the two-way quick cylinder in the present technical solution.

FIG. 4 is a sectional view of the two-way quick cylinder in the present technical solution.

FIG. 5 is an enlarged view of FIG. 4 at point B.

FIG. 6 is a sectional view of Section A-A in FIG. 4.

FIG. 7 is a schematic diagram for the structure of the power unit in the present technical solution.

FIG. 8 is a sectional view for the local part of the power unit in the present technical solution.

FIG. 9 is schematic diagram I for the structure of the main beam in the present technical solution.

FIG. 10 is schematic diagram II for the structure of the main beam in the present technical solution.

FIG. 11 is side view of the main beam in the present technical solution.

FIG. 12 is a schematic diagram for the structure of the baffle in the present technical solution.

FIG. 13 is a schematic diagram for the structure of the wood splitting axe in the present technical solution.

FIG. 14 is side view of the wood splitting axe in the present technical solution.

Reference numerals: 1. Frame; 11. Main beam; 12. Tail plate; 13. Reinforcing plate; 14. Reinforcing rib plate; 15. Working space; 16. Guide plate; 17. Guide rail; 2. Baffle; 21. Reinforcing rib; 22. Reinforcing ring; 23. Fixing protrusion; 3. Wood splitting axe; 30. Fixing portion; 31. Force-bearing main body; 32. Guide portion I; 33. Blade portion; 34. Cutting edge; 35. Knife edge portion; 36. First blade portion; 37. Second blade portion; 4. Two-way quick cylinder; 41. Hydraulic oil cylinder body; 411. Cylinder body; 412. Cylinder front cover; 413. Cylinder rear cover; 414. Cylinder steel pipe; 415. Double-lug mounting ring; 42. Large piston; 421. Mounting chamber; 422. Auxiliary piston chamber; 43. Piston rod; 441. Push rod seat; 4411. First through hole; 4412. Control oil hole; 4413. Guide portion II; 442. Push rod assembly; 4421. Sliding seat; 4422. Push rod body; 4423. Third spring; 4424. Limiting platform; 443. Oil passage; 45. Rod chamber; 46. Rodless chamber; 47. Hydraulically controlled one-way valve; 471. First steel ball; 472. First spring; 5. Power unit; 51. Engine; 52. Adapter plate; 53. Oil pump; 54. Oil tank; 6. Control unit; 60. Oil circuit board; 601. Third through hole; 61. Control valve; 63. Control handle; 64. Connecting oil pipe; 7. Hydraulically controlled switching valve; 711. Second through hole; 72. Thrust controlled push rod valve core; 73. Second steel ball; 74. Second spring; 8. Quick reset unit; 81. Hollow perforated inner pull rod; 82. Small piston; 821. Reset area; 822. Avoidance area; 9. Wood tray.

### DETAILED DESCRIPTION OF THE EMBODIMENTS

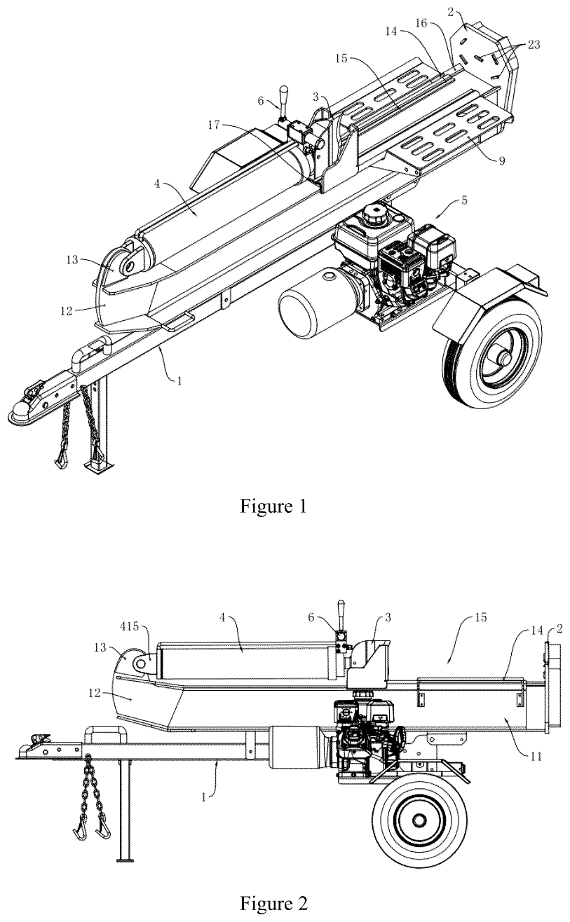

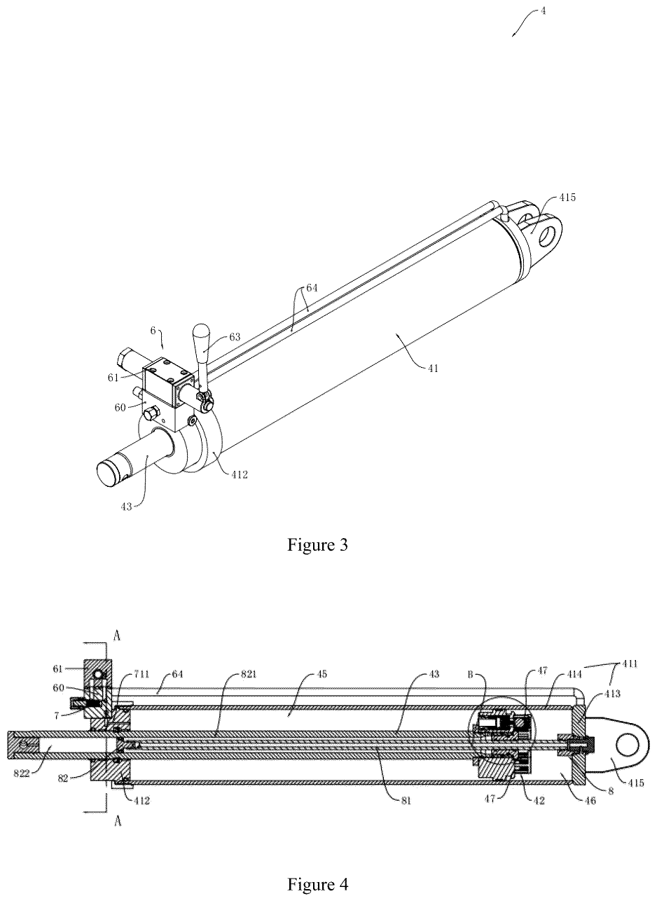

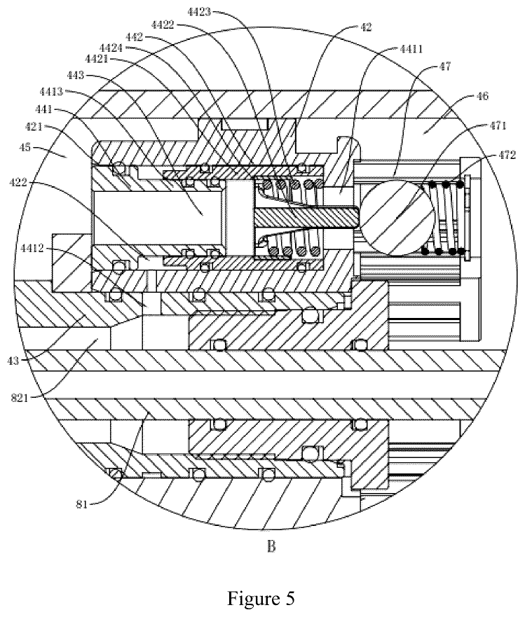

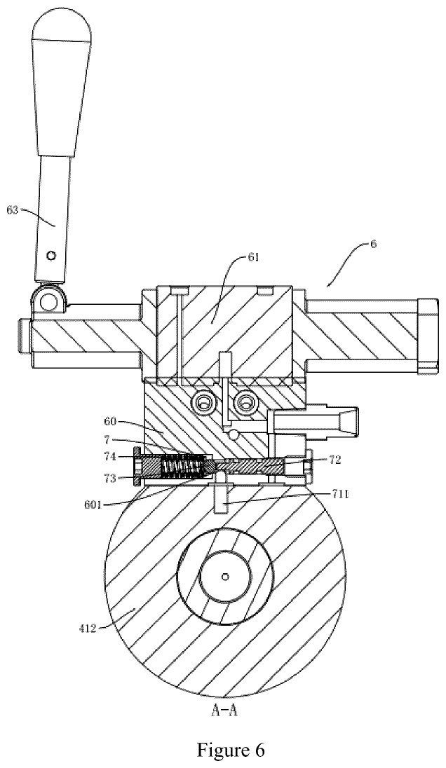

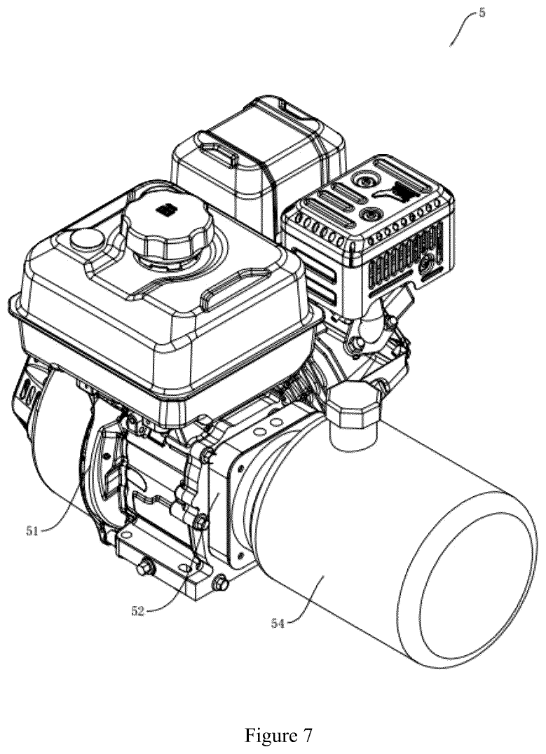

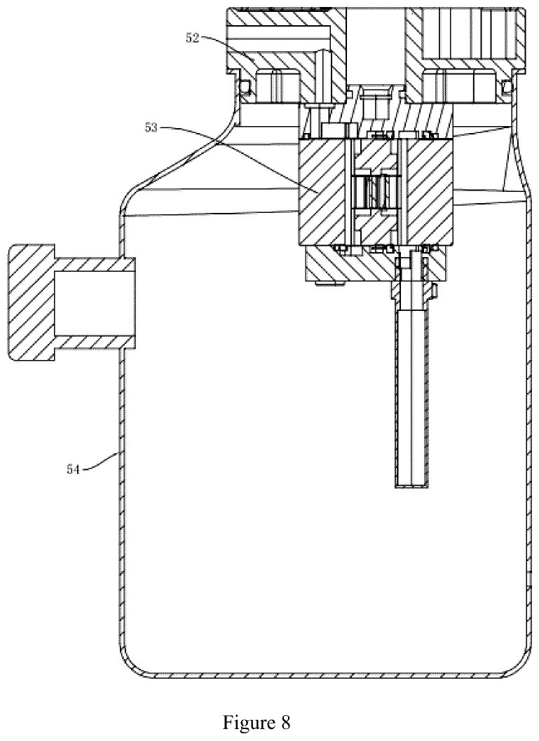

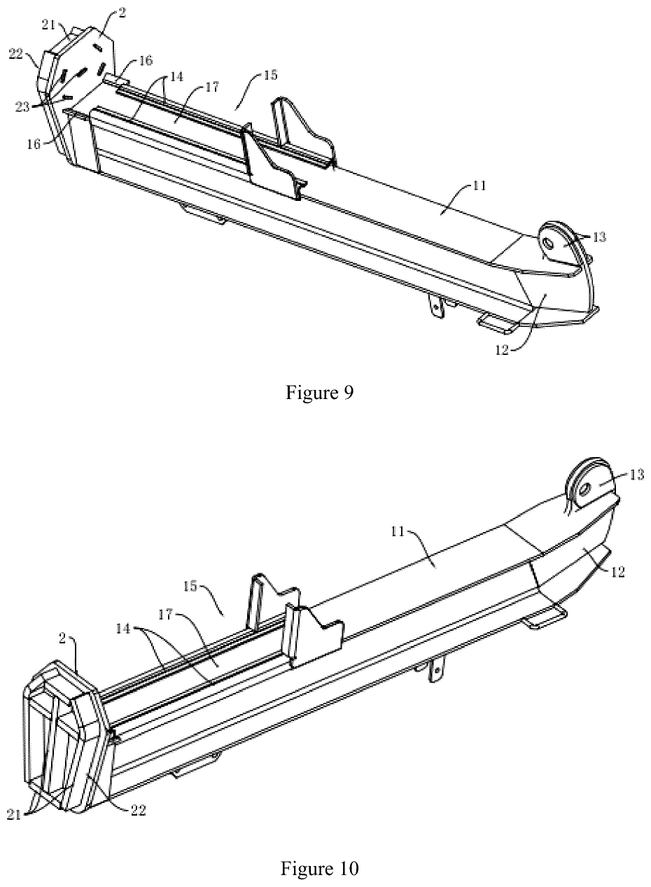

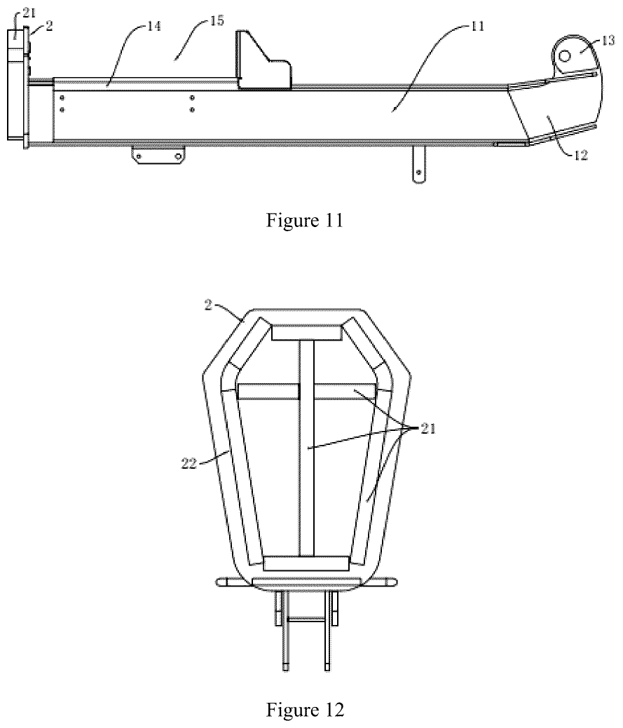

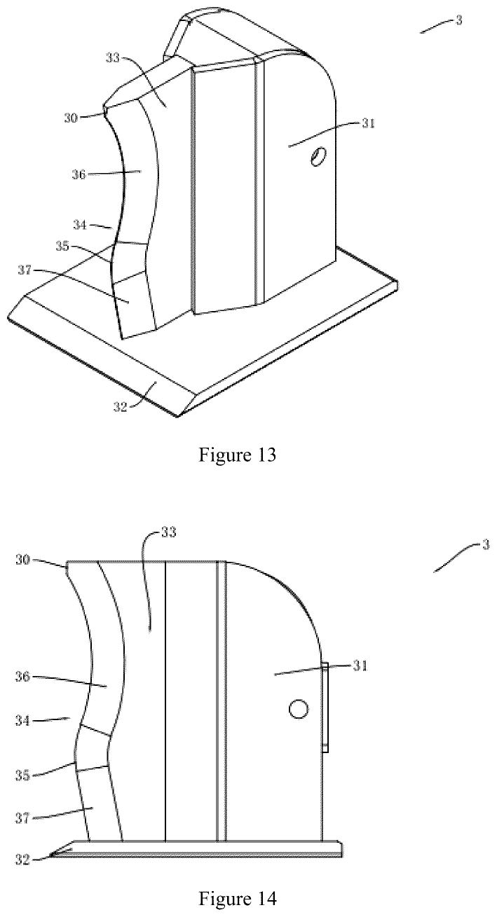

The present technical solution will be further described below with reference to specific embodiment in conjunction with the drawings. See FIGS. 1 to 14.

A two-way quick cylinder, comprises: a hydraulic oil cylinder body 41; a large piston 42, which is slidably provided in the hydraulic oil cylinder body 41 and divides the inner chamber of the hydraulic oil cylinder body 41 into a rod chamber 45 and a rodless chamber 46; a piston rod 43, which is telescopically installed on the hydraulic oil cylinder body 41, one end of the piston rod 43 extends into the rod chamber 45 to be connected with the large piston 42, and the other end extends out of the hydraulic oil cylinder body 41 to form a driving end; and a hydraulically controlled one-way valve 47, which is installed on the large piston 42 to be used for communicating the rod chamber 45 and the rodless chamber 46;

When the oil pump 53 pumps hydraulic oil into the rodless chamber 46 to drive the large piston 42 to move, the size of the rod chamber 45 is reduced along with the movement of the large piston 42, making pressure in the rod chamber 45 increase and the hydraulically controlled one-way valve 47 open, so that the hydraulic oil in the rod chamber 45 enters the rodless chamber 46 through the hydraulically controlled one-way valve 47 and pushes the large piston 42 to move along with the hydraulic oil pumped by the oil pump.

When the two-way quick cylinder 4 is in light-load or no-load working conditions, the oil pump 53 pumps hydraulic oil into the rodless chamber 46 through the oil inlet pipeline. At this time, the rod chamber 45 is in a fully closed state, and the large piston 42 slides along the hydraulic oil cylinder body 41 to reduce the volume of the rod chamber 45, so that the hydraulic oil pressure in the rod chamber 45 is greater than that in the rodless chamber 46, the hydraulically controlled one-way valve 47 automatically opens, and the hydraulic oil in the rod chamber 45 directly enters the rodless chamber 46 through the hydraulically controlled one-way valve 47. At this moment, since the hydraulic oil of the rodless chamber 46 with the volume increased comes from both the external oil pump 53 and the rod chamber 45, and about more than seven times of hydraulic oil comes from the rod chamber 45; compared with conventional oil cylinders, the oil pump 53 only needs to pump less than one-seventh of the flow rate to obtain a faster speed than the conventional oil cylinders; realizing the quick pushing action of the piston rod 43 driven at a small flow rate; when the piston rod 43 is pushed out, the hydraulic oil in the rod chamber 45 can enter the rodless chamber 46 in light-load or no-load working conditions through the hydraulically controlled one-way valve 47; and when the piston rod 43 is retracted, the hydraulic oil in the rodless chamber 46 can enter the rod chamber 45 through the hydraulically controlled one-way valve 47, thereby realizing the quick functions in two directions of pushing out and retracting for the piston rod 43 with a smaller pump-in flow, which sharply reduces the energy consumption of the hydraulic system, achieves environmental protection and energy saving, and reduces pollution to the environment. In addition, because the amount of pumped-in oil is reduced, the total demand for hydraulic oil is directly reduced, the power of the driving force is greatly reduced, and the delivery and control costs of the hydraulic oil are reduced, thereby greatly reducing the manufacturing cost and use cost of the product.

The two-way quick cylinder also comprises a quick reset unit 8, which is used to control the oil in the rodless chamber 46 to return to the rod chamber 45 through the hydraulically controlled one-way valve 47; and the quick reset unit 8, which comprises, to achieve the quick reset of the piston rod 43, a hollow perforated inner pull rod 81, a small piston 82, a push rod seat 441 and a push rod assembly 442;

The piston rod 43 is hollow;

One end of the hollow perforated inner pull rod 81 is connected and fixed to the cylinder rear cover 413 of the hydraulic oil cylinder body 41, the other end passes through the large piston 42 and extends into the inner chamber of the piston rod 43, and the hollow perforated inner pull rod 81 is slidably connected to the large piston 42; and the end of the piston rod 43 is connected with a sealing plug through inner threads, the sealing plug is sleeved on the outer side of the hollow perforated inner pull rod 81 to be connected in a sealing manner, the rear end of the sealing plug is provided with an abutment platform, which movably abuts against the rear ends of the large piston 42 and the piston rod 43, and the sealing plug cooperates with the small piston 82 and the hollow perforated inner pull rod 81 to form a reset area 821;

The large piston 42 is provided with a mounting chamber 421, and a push rod seat 441 and a push rod assembly 442 are provided in the mounting chamber 421; an oil passage 443 communicating the rod chamber 45 and the hydraulically controlled one-way valve 47 is formed in the middle of the push rod seat 441 and the push rod assembly 442; the portion of the push rod seat 441 adjacent to the hydraulically controlled one-way valve 47 is a second guide portion II 4413, and an auxiliary piston chamber 422 is formed between the peripheral side of the guide portion II 4413 and the side wall of the mounting chamber 421, one end of the push rod assembly 442 is provided in the auxiliary piston chamber 422 to form a piston portion, and the other end of the push rod assembly 442 faces the hydraulically controlled one-way valve 47;

The small piston 82 is connected to one end of the hollow perforated inner pull rod 81, and the peripheral side of the small piston 82 is slidably connected to the inner wall of the piston rod 43. The small piston 82 divides the inner chamber of the piston rod 43 into a reset area 821 and an avoidance area 822; the reset area 821 is communicated to the oil circuit inside the hollow perforated inner pull rod 81; a control oil hole 4412 is provided on the piston rod 43, the control oil hole 4412 is communicated to the reset area 821, and the control oil hole 4412 makes the oil circuit between the reset area 821 and the auxiliary piston chamber 422 communicated; and when hydraulic oil in the reset area 821 enters the auxiliary piston chamber 422, the push rod assembly 442 drives the hydraulically controlled one-way valve 47 to open.

The hydraulic oil flows into the hollow perforated inner pull rod 81 through the oil pump 53 and then into the reset area 821. The hydraulic oil in the reset area 821 enters the auxiliary piston chamber 422 through the control oil hole 4412 and pushes the push rod assembly 442 to move, thereby controlling the hydraulically controlled one-way valve 47 to open.

The oil pump 53 pumps hydraulic oil into the reset area 821 through the hollow perforated inner pull rod 81. Since the reset area 821 is communicated with the auxiliary piston chamber 422 through the control oil hole 4412, the hydraulic oil in the reset area 821 acts on the push rod assembly 442 and pushes the first steel ball 471, controlling the hydraulically controlled one-way valve 47 to open. At this time, the rodless chamber 46 and the rod chamber 45 are communicated, and the hydraulic oil in the rodless chamber 46 directly returns to the rod chamber 45 through the hydraulically controlled one-way valve 47, so that the large piston 42 retreats quickly to complete the reset action of the piston rod 43; and the designed quick reset unit 8, through the hollow piston rod 43, the hollow perforated inner pull rod 81 and the small piston 82, constitutes a reset small oil cylinder structure, which can realize the quick reset action of the piston rod 43.

A control unit 6 is provided on the hydraulic oil cylinder body 41. The control unit 6 is communicated to the power unit 5 through an oil pipeline. The control unit 6 comprises a control valve 61, a bouncing reset mechanism and a control handle 63. The control valve 61 is in plate connection with the cylinder front cover 412. The plate connection means that the control valve 61 and the cylinder front cover 412 are superimposed and fastened together in a plane to form a compact and orderly whole, which is convenient for installation, maintenance and system integration. Specifically, the plate connection means that all the control units (i.e. the control valve 61 and the cylinder front cover 412) are stacked in a plane, that is, they are stacked and connected together layer by layer to realize integration. The two mutually adjacent planes of the control valve 61 and the cylinder front cover 412 are fitted together, and the two planes are provided with through holes in the middle and are aligned and connected with each other;

The control valve 61 communicates the cylinder front cover 412 and the cylinder rear cover 413 through two connecting oil pipes 64. The flow direction of the hydraulic oil in the oil steel pipe can be controlled by operating the control handle 63. The bouncing reset mechanism enables the control valve handle to automatically return to the neutral position when the piston rod 43 is retracted in place during the resetting process of the two-way quick cylinder 4.

In the present technical solution, the control valve 61 and the cylinder front cover 412 of the hydraulic oil cylinder body 41 are in plate connection, the control valve 61 and the cylinder rear cover 413 are communicated through two connecting oil pipes 64, then the control valve 61 is communicated to the cylinder front cover 412, and the control valve 61 is used to control the connecting oil pipes 64 to supply oil to the rodless chamber 46 or the reset area 821 respectively.

The hydraulically controlled one-way valve 47 comprises a first steel ball 471 and a first spring 472;

The push rod seat 441 and the push rod assembly 442 are hollow, and a first through hole 4411 is opened on the large piston 42. The rodless chamber 46 passes through the first through hole 4411 and communicates with the rod chamber 45 along the hollow of the push rod assembly 442 and the push rod seat 441.

One end of the first spring 472 is connected to the large piston 42 through a clasp, and the other end is connected to the said first steel ball 471, making the first steel ball 471 block the first through hole 4411;

The end of the push rod assembly 442 is slidably sleeved on the push rod seat 441, and the push rod seat 441 is used to limit the push rod assembly 442 to be separated from the large piston 42. The push rod assembly 442 is slidably connected in the mounting chamber 421 of the large piston 42, and the push rod body 4422 of the push rod assembly 442 can pass through the first through hole 4411 to abut against the first steel ball 471;

The push rod assembly 442 can be in contact with hydraulic oil in the reset area 821. Under the action of oil pressure, the hydraulic oil in the reset area 821 pushes the push rod assembly 442 to abut against the first steel ball 471 through the control oil hole 4412 and push away, making the first steel ball 471 no longer block the first through hole 4411, so as to realize the communication of the rod chamber 45 and the rodless chamber 46.

During the light-load operation, the oil pump 53 continuously pumps hydraulic oil into the rodless chamber 46. The hydraulic oil in the rodless chamber 46 applies thrust to the large piston 42 while the oil pressure increases. Since the rod chamber 45 is sealed at this time, the pressure of hydraulic oil in the rod chamber 45 increases rapidly, the hydraulic oil in the rod chamber 45 directly pushes the first steel ball 471 away, and the first steel ball 471 no longer blocks the first through hole 4411. The rod chamber 45 and the rodless chamber 46 are communicated through the first through hole 4411. The hydraulic oil in the rod chamber 45 directly enters the rodless chamber 46 through the first through hole 4411. Since most of the hydraulic oil is the hydraulic oil replenished from the rod chamber 45 to the rodless chamber 46, the oil pump 53 only needs a very small flow rate to obtain a faster pushing speed and, when the piston rod 43 is reset, the hydraulic oil in the reset area 821 pushes the push rod assembly 442 to move, the push rod assembly 442 pushes the first steel ball 471 to move, the first through hole 4411 opens, and the hydraulic oil in the rodless chamber 46 enters the rod chamber 45 through the first through hole 4411 to complete the rapid reset; and the designed hydraulically controlled one-way valve 47 can achieve high-speed pushing and rapid reset by driving with a small flow in light-load working conditions.

The push rod assembly 442 comprises a sliding seat 4421, a push rod body 4422 and a third spring 4423;

The sliding seat 4421 is slidably sleeved on the push rod seat 441, the rear half of the sliding seat 4421 is slidably provided in the auxiliary piston chamber 422 to form a piston portion, the push rod body 4422 is slidably provided in the front half of the sliding seat 4421, one end of the push rod body 4422 movably abuts against the limiting platform 4424 in the sliding seat 4421, and the other end passes through the first through hole 4411 to abut against the first steel ball 471; and one end of the third spring 4423 movably abuts against the push rod body 4422, and the other end movably abuts against the edge of the first through hole 4411, making the push rod body 4422 have a movement trend of being away from the first steel ball 471, thereby realizing the resetting of the push rod assembly 442.

A hydraulically controlled switching valve 7 is integrated on the control unit 6 or the cylinder front cover 412. When the hydraulic oil pressure in the rodless chamber 46 reaches a set value P, the hydraulically controlled switching valve 7 makes the rod chamber 45 communicate with the oil return line.

In heavy-load working conditions, since the piston rod 43 is subjected to greater force, the oil pump 53 continuously pumps hydraulic oil into the rodless chamber 46, causing the hydraulic oil pressure in the rodless chamber 46 to continuously increase, thereby enabling the thrust on the large piston 42 to gradually increase. Once the hydraulic oil pressure in the rodless chamber 46 reaches P, the hydraulically controlled switching valve 7 on the control unit 6 or the cylinder front cover 412 opens under the action of hydraulic oil pressure in the rodless chamber 46, causing the rod chamber 45 to be communicated with the oil return line. The originally closed rod chamber 45 is suddenly communicated with the oil return line, and the hydraulic oil pressure in the rod chamber 45 can be regarded as instantly dropping to 0. At this time, the oil pressure in the rodless chamber 46 is greater than that in the rod chamber 45, the hydraulically controlled one-way valve 47 on the large piston 42 is automatically closed immediately, and the high-pressure hydraulic oil in the rodless chamber 46 completely acts on the large piston 42, generating the same huge thrust as a conventional oil cylinder to complete the heavy-load operation; and the designed hydraulically controlled switching valve 7 can control the flow direction of the hydraulic oil in the rod chamber 45. When the system oil pressure reaches the set pressure, the hydraulically controlled switching valve 7 automatically opens, making the hydraulic oil in the rod chamber 45 communicate with the oil tank 54, and the automatic switching of light-load and heavy-load working conditions can be completed through cooperation with the hydraulically controlled one-way valve 47, fundamentally solving the problem of contradiction among thrust, speed and driving power in uneven load working conditions, achieving the heavy-load operation through a simple structure, and reducing the high manufacturing costs caused by the use of complex hydraulic systems such as tandem pumps.

A second through hole 711 is provided on the oil cylinder front cover 412, and the rod chamber 45 and the oil return line are communicated through the second through hole 711;

The control valve 61 is connected to an oil circuit board 60, the oil circuit board 60 is mounted on the cylinder front cover 412, a third through hole 601 is provided on the oil circuit board 60, and the oil return line and the second through hole 711 are communicated through the third through hole 601;

The cylinder rear cover 413 is communicated with the oil circuit board 60 through two connecting oil pipes 64, and the control valve 61 is used to control the connecting oil pipes 64 connected on the oil circuit board 60 so as to be communicated with the rodless chamber 46 or the reset area 821;

The hydraulically controlled switching valve 7 comprises a thrust controlled push rod valve core 72, a second steel ball 73 and a second spring 74; and one end of the second spring 74 is enclosed in the oil circuit board 60 through the screw plug, and the other end is connected to the second steel ball 73, making the second steel ball 73 block the third through hole 601;

The thrust controlled push rod valve core 72 is slidably connected in the oil circuit board 60, and the push rod of the thrust controlled push rod valve core 72 can pass through the third through hole 601 to abut against the second steel ball 73.

The hydraulically controlled switching valve 7 can be integrated into the control unit 6 or the cylinder front cover 412, that is, the oil circuit board 60 can be integrated with the control valve 61 and then installed on the cylinder front cover 412, or the oil circuit board 60 can be directly designed as an integral part of the cylinder front cover 412, and then the control valve 61 is in plate connection with the cylinder front cover 412.

In the heavy-load working conditions, the piston rod 43 initially remains stationary, and the oil pump 53 pumps hydraulic oil into the rodless chamber 46 continuously. The oil pressure in the rodless chamber 46 continuously increases to the set value P, and the rodless chamber 46 is communicated with the force application chamber of the thrust controlled push rod valve core 72 through the oil circuit (that is, the oil circuit board 60 and the rodless chamber 46 are connected through a connecting oil pipe 64, and the connecting oil pipe 64 can be used to supply oil to the rodless chamber 46, and can also be used to deliver the hydraulic oil in the rodless chamber 46 to the oil circuit board 60 and apply force to the thrust controlled push rod valve core 72, or the rodless chamber 46 is connected through a new connecting oil pipe 64 to realize force application through the hydraulic oil in the rodless chamber 46 for the thrust controlled push rod valve core 72). At this time, the thrust controlled push rod valve core 72 applies force to the second steel ball 73 under the action of hydraulic oil pressure in the rodless chamber 46, making the second steel ball 73 overcome the elastic force of the second spring 74, and the third through hole 601 is opened to be communicated with the second through hole 711. At this moment, the rod chamber 45 is communicated with the oil return line, the hydraulic oil pressure in the rod chamber 45 is reduced rapidly, the hydraulically controlled one-way valve 47 on the large piston 42 is automatically closed immediately, and all the high-pressure oil in the rodless chamber 46 acts on the large piston 42, generating a huge thrust to complete the heavy-load operation; and the designed hydraulically controlled switching valve 7 can cooperate with the hydraulically controlled one-way valve 47 to realize the immediate and automatic switching between the heavy-load working conditions and the light-load working conditions.

The hydraulic oil cylinder body 41 comprises a cylinder body 411, a cylinder front cover 412 installed on the cylinder body 411, a cover and a control valve 61 in plate connection with the cylinder front cover 412, and the cover is used to connect and fix the cylinder body 411 with the cylinder front cover 412; the cylinder body 411 comprises a cylinder steel pipe 414 and a cylinder rear cover 413, wherein the cylinder steel pipe 414, the cylinder rear cover 413 and two connecting oil pipes 64 are welded into a whole, the cylinder rear cover 413 is welded with a double-lug mounting ring 415, and the cylinder rear cover 413 is provided with an ejection oil hole communicating the rodless chamber 46 and the control valve 61 as well as a retraction oil hole communicating the hollow perforated inner pull rod 81 and the control valve 61; and the ejection oil hole and the retraction oil hole are connected with one connecting oil pipe 64 respectively, making the hydraulic oil pass through the oil circuit board 60 and the connecting oil pipe 64 to enter the rodless chamber 46 or the inside of the hollow perforated inner pull rod 81 by operating the control valve 61, and the two connecting oil pipes 64 are directly inserted into the said control valve 61 during the installation.

A wood splitter, comprises: a frame 1, a baffle 2, a wood splitting axe 3, a two-way quick cylinder 4 and a power unit 5; and an oil pump 53, which is provided in the oil tank 54, and is integrated with the engine 51 through an adapter plate 52;

A traction unit is provided on the frame 1; and the traction unit comprises a connecting rod, a traction head and two traction chains, one end of the connecting rod is horizontally bolted to the frame 1, the other end is bolted to the traction head, one end of the traction chain is welded to the connecting rod, and the connection between the traction chain and the connecting rod is arranged close to the traction head.

The two-way quick cylinder 4 is installed on the frame 1, the baffle 2 is vertically welded on the frame 1, the wood splitting axe 3 is installed on the piston rod 43 of the two-way quick cylinder 4, and a working space 15 for placing wood is formed among the frame 1, the baffle 2 and the wood splitting axe 3. In order to facilitate the temporary storage of woods, two wood trays 9 are installed on the frame 1 in a hinged manner, and the two wood trays 9 are respectively located on opposite sides of the working space 15; and the power unit 5 is installed on the frame 1 to provide power for the two-way quick cylinder 4;

Among them, the power unit 5 comprises an engine 51, an adapter plate 52, an oil pump 53 and an oil tank 54; and the oil pump 53 is provided in the oil tank 54, and is integrated with the engine 51 through the adapter plate 52.

The base of the engine 51 is bolted to the frame 1, one side of the adapter plate 52 in the thickness direction is bolted to the engine 51, the other side is bolted to the oil pump 53, and the output shaft of the engine 51 passes through the adapter plate 52 to be in key connection with the input shaft of the oil pump 53; and the oil tank 54 is provided on the outer peripheral side of the oil pump 53 in a housing manner, and the oil tank 54 is connected with the screw plug of the adapter plate 52, and the oil pump 53 is connected to the control unit 6 through the oil circuit in the adapter plate 52 and the oil pipeline successively, and delivers hydraulic oil to the reset area 821 or the rodless chamber 46 through the control unit 6.

The oil pipeline comprises an oil inlet pipeline and an oil return pipeline. The oil return pipeline is used for enabling the hydraulic oil to flow back to the oil tank 54; and the oil inlet pipeline is used for enabling the hydraulic oil to flow into the oil circuit board 60 for distribution through the oil circuit board 60 and then be delivered to the rodless chamber 46 or the reset area 821.

The oil inlet end of the oil pump 53 enables the hydraulic oil in the oil tank 54 to enter the oil pump 53 through the oil pipe, the oil outlet end of the oil pump 53 is communicated to the adapter plate 52 through the oil circuit, and the adapter plate 52 and the oil tank 54 are connected through the oil circuit to realize the hydraulic oil returning from the adapter plate 52 to the oil tank 54.

The frame 1 is provided with a main beam 11, the base of the main beam 11 is made of H-shaped steel, and the main beam 11 is formed by cutting the integral profile. Compared with the conventional main beam 11 formed by welding three plates, the present design scheme reduces the processing steps of the main beam 11, and the integral forming of the main beam 11 can improve the bearing capacity; the cross section of the main beam 11 is H-shaped; the tail end of the main beam 11 is bent and warped upwards, and the tail end of the main beam 11 is inlaid and welded with a tail plate 12, reinforcing plates 13 are provided on both sides of the tail plate 12, and the end of the two-way quick cylinder 4 is installed on the reinforcing plates 13 and the tail plate 12, and the double-lug mounting ring 415 of the two-way quick cylinder 4 is hinged on the tail plate 12 and the reinforcing plates 13; and a mounting groove is firstly opened at the tail end of the main beam 11, the tail plate 12 is vertically inlaid in the mounting groove to be fixed by welding, the upper end of the tail plate 12 protrudes from the upper end of the main beam 11, the two sides of the tail plate 12 are welded to the side walls of the mounting groove, and the front end of the tail plate 12 abuts against the bottom of the mounting groove to be welded together;

When the two-way quick cylinder 4 performs a wood splitting operation, the tail plate 12 is subjected to excessive force due to the backward movement of the reaction force. The tail plate 12 only needs to be made of metal such as steel, thereby improving the bearing capacity and reducing the production cost.

Reinforcing rib plates 14 are provided on both sides of the main beam 11. The upper ends of the reinforcing rib plates 14 are bent and placed above the main beam 11. A gap for the guide portion I 32 to slide is reserved between the bent portion at the upper end of the reinforcing rib plate 14 and the upper end of the main beam 11 (that is, the bottom of the guide portion I 32 is slidably provided on the upper end of the main beam 11, the reinforcing rib plate 14 first wraps around the side wall of the guide portion I 32, and then the upper end of the reinforcing rib plate 14 is bent and placed on the upper end of the guide portion I 32), thereby forming a guide rail 17 for the wood splitting axe 3 to slide, which is used to limit the wood located in the working space 15, so that the stability of the wood is ensured during the splitting or moving, and the removal of wood chips is guaranteed.

Guide plates 16 are obliquely provided on both sides of the main beam 11, that is, the upper ends of the guide plates 16 are bent toward the direction away from the upper end of the main beam 11, and the said guide plates 16 are located between the guide rail 17 and the baffle 2. While the guide plates 16 and the guide rail 17 are used for positioning the wood together, the guide plates 16 can increase the strength of the main beam 11 and the baffle 2, and meanwhile the guide plates 16 can smoothly remove the residual wood chips.

A plurality of reinforcing ribs 21 are provided on the side of the baffle 2 away from the wood splitting axe 3, the plurality of reinforcing ribs 21 are connected end to end to form reinforcing rings 22 by welding at the connections, and the inner walls of the reinforcing rings 22 are connected by welding through the reinforcing ribs 21, thereby increasing the bearing capacity of the baffle 2.

A plurality of fixing protrusions 23 are provided on the side of the baffle 2 close to the wood splitting axe 3 for fixing the end of the wood.

The wood splitting axe 3 is in an S-type eagle head shape. It comprises a force-bearing main body 31, a guide portion I 32 and a blade portion 33; the guide portion I 32 is located at the lower side of the force-bearing main body 31 and the blade portion 33 and is provided horizontally, the force-bearing main body 31 is provided vertically above the guide portion I 32, the blade portion 33 is provided on the side of the force-bearing main body 31 away from the two-way quick cylinder 4, and the front end of the blade portion 33 is provided with a cutting edge 34;

The cutting edge 34 is S-shaped, and a fixing portion 30 is provided on the upper side thereof, and the fixing portion 30 is used to fix the wood; and a knife edge portion 35 is provided on the lower half of the cutting edge 34 in a protruding manner, and the knife edge portion 35 is used to split the wood;

The fixing portion 30 is farther away from the two-way quick cylinder 4 than the knife edge portion 35; an arc-shaped concave first blade portion 36 is formed between the fixing portion 30 and the knife edge portion 35. After the fixing portion 30 is positioned, the first blade portion 36 will pull the wood downwards to further stabilize the wood. Its role is particularly prominent when the wood is split into two and then into four during the splitting process. When the knife edge portion 35 is located close to the outer periphery of the wood, it is more conducive to splitting the wood; and a second blade portion 37 inclined inwardly is formed on the lower side of the knife edge portion 35.

When the wood to be split in the working space 15 formed by the frame 1, the baffle 2 and the wood splitting axe 3, before the wood splitting axe 3 touches the wood and after the moment of splitting the wood with great force, the oil cylinder is in light-load or no-load working conditions, the power unit 5 pumps hydraulic oil into the rodless chamber 46, the hydraulically controlled one-way valve 47 is automatically opened, and the hydraulic oil in the rod chamber 45 directly enters the rodless chamber 46 through the hydraulically controlled one-way valve 47. At this moment, since the hydraulic oil required by the rodless chamber 46 with the volume increased comes from both the external oil pump 53 and the rod chamber 45, and the majority comes from the rod chamber 45, compared with conventional oil cylinders, the quicker pushing action of the piston rod 43 is realized, the waiting time for the wood splitting axe 3 touching the wood again after resetting is shortened, and the working efficiency of the wood splitter is increased. In addition, the energy consumption of the hydraulic system is sharply reduced, achieving environmental protection and energy saving, and reducing pollution to the environment. Furthermore, because the amount of pumped-in oil is reduced, the total demand for hydraulic oil is directly reduced, and the delivery and control costs of the hydraulic oil are reduced, thereby greatly reducing the manufacturing cost and use cost of the product.

After the wood splitting axe 3 touches the wood, the hydraulic oil cylinder body 41 is automatically switched to the heavy-load working conditions. Since the piston rod 43 is subjected to greater force, the power unit 5 continuously pumps hydraulic oil into the rodless chamber 46, causing the hydraulic oil pressure in the rodless chamber 46 to continuously increase, thereby enabling the thrust on the large piston 42 to gradually increase. Once the hydraulic oil pressure in the rodless chamber 46 reaches the set value P, the hydraulically controlled switching valve 7 on the cylinder front cover 412 opens under the action of hydraulic oil pressure in the rodless chamber 46, causing the rod chamber 45 to be communicated with the oil return line. The originally closed rod chamber 45 is suddenly communicated with the oil return line, and the hydraulic oil pressure in the rod chamber 45 can be regarded as instantly dropping to 0. At this time, the oil pressure in the rodless chamber 46 is greater than that in the rod chamber 45, the hydraulically controlled one-way valve 47 on the large piston 42 is automatically closed immediately, and the high-pressure hydraulic oil in the rodless chamber 46 completely acts on the large piston 42, generating a huge thrust to split the wood instantly and complete the heavy-load operation, after the wood is split, the load is reduced sharply to instantly convert into the light-load working conditions, and the piston rod 43 is pushed out rapidly to complete the wood splitting operation; and the designed hydraulically controlled switching valve 7 can complete the automatic switching of the light-load and the heavy-load working conditions through cooperation with the hydraulically controlled one-way valve 47, making the oil cylinder have a fast speed and huge thrust driven by small power; and the problem of contradiction among thrust, speed and driving power in uneven load working conditions is fundamentally solved.

The designed quick reset unit 8 can realize the quick reset action of the piston rod 43, reduce the waiting time for the wood splitting axe 3 to reset, and further improve the working efficiency of the wood splitter.

The engine 51 provides power for the oil pump 53, the oil pump 53 pumps the hydraulic oil from the oil tank 54 to the rodless chamber 46 through the adapter plate 52 and the oil inlet pipeline successively so as to complete the extension of the piston rod 43 and the wood splitting operation, and after the wood splitting operation is completed, the oil pump 53 pumps the hydraulic oil to the cavity of the hollow perforated inner pull rod 81 to complete the reset action of the piston rod 43; and the designed power unit 5 can reduce the volume of the oil tank 54 due to the small hydraulic oil flow required by the hydraulic system, and through the design of the adapter plate 52, the connecting oil pipes 64 of the existing wood splitter are eliminated, so that the hidden risks such as the potential occurrence of failures due to oil leakage can be reduced. In addition, because the power of the wood splitter has no direct correlation and restriction relationship with the thrust and speed, the power unit 5 of the present application can be adapted to wood splitters of various specifications and sizes, thereby saving the manufacturing and management costs.

The designed control unit 6 and connecting oil pipes 64 are highly integrated with the hydraulic oil cylinder body 41, making the product structure compact and beautiful while reducing the manufacturing cost, so that the hidden quality risk of oil leakage in the hydraulic system is reduced.

The working principle of this design is as follows: The wood to be split is placed on the wood tray 9, and then a piece of wood is enabled to enter the working space 15. The control handle 63, making the engine 51 drive the oil pump 53 to pump out high-pressure oil, which enters the rodless chamber 46 successively through the adapter plate 52, the oil inlet pipe, the oil circuit board 60 and the connecting oil pipe 64. Since the external load is relatively small, the hydraulic oil pumped into the rodless chamber 46 increases the oil pressure of the rodless chamber 46, and the hydraulic oil in the rodless chamber 46 pushes the large piston 42 to slide. At this time, the rod chamber 45 is completely closed, and the hydraulic oil pressure in the rod chamber 45 increases rapidly until the hydraulic oil pressure in the rod chamber 45 is greater than that in the rodless chamber 46. The oil pressure in the rod chamber 45 acts on the first steel ball 471 and overcomes the elastic force of the first spring 472 to push the first steel ball 471 away, and the first through hole 4411 is opened. At this moment, the hydraulic oil in the rod chamber 45 directly enters the rodless chamber 46 through the first through hole 4411. Since most of the hydraulic oil in the rodless chamber 46 comes from the rod chamber 45, the flow rate equivalent to one-seventh of the flow in a conventional oil cylinder is only needed for the oil pump to obtain a faster ejection speed than a conventional oil cylinder; and therefore, the rapid pushing of the piston rod 43 driven by a small flow can be realized until the wood splitting axe 3 touches the wood.

When the wood splitting axe 3 comes into contact with the wood, the oil pump 53 continues to pump hydraulic oil into the rodless chamber 46. Due to the heavy load, the piston rod 43 and the large piston 42 remain stationary until the hydraulic oil pressure in the rodless chamber 46 rises to the set value P. At this time, the hydraulic oil in the rodless chamber 46 in turn applies force to the thrust controlled push rod valve core 72 in the oil circuit board 60 through the oil circuit (i.e. the oil circuit connecting oil pipe 64 and the oil circuit board 60), and the thrust controlled push rod valve core 72 applies force to the second steel ball 73, making the second steel ball 73 overcomes the elastic force of the second spring 74 and no longer blocks the third through hole 601. The rod chamber 45 and the oil return line are communicated through the third through hole 601 and the second through hole 711, and the hydraulic oil pressure in the rod chamber 45 decreases rapidly. At this moment, the hydraulic oil pressure in the rodless chamber 46 is greater than that in the rod chamber 45, the hydraulically controlled one-way valve 47 on the large piston 42 is automatically closed immediately, and the high-pressure hydraulic oil in the rodless chamber 46 completely acts on the large piston 42, generating a huge thrust, and making the wood splitting axe 3 split the wood. When the wood is split instantly, the load of the oil cylinder immediately decreases, the oil pressure in the rodless chamber 46 drops accordingly, the hydraulic pressure on the thrust controlled push rod valve core 72 is less than the elastic force of the second spring 74, and the second steel ball 73 is immediately reset to close the second through hole; and so that the rod chamber 45 is in the closed state again. Once the rod chamber 45 is closed, its oil pressure immediately rises and exceeds the pressure of the rodless chamber 46, enabling the first steel ball 471 to be directly pushed away, so that all the hydraulic oil in the rod chamber 45 flows into the rodless chamber 46 to quickly push out the piston rod 43 completely; and so that the wood is completely split.

After the wood is completely split, the piston rod 43 needs to be reset. At this time, the control handle 63 is operated, making the engine 51 drive the oil pump 53 to pump out high-pressure oil, which flows into the inner cavity of the hollow perforated inner pull rod 81 through the adapter plate 52 and the oil inlet pipeline successively to enter the reset area 821, and then the piston rod 43 and the large piston 42 are quickly pulled back under the action of the hydraulic oil. At this time, the hydraulic oil in the reset area 821 applies force to the push rod assembly 442 through the control oil hole 4412, making the push rod assembly 442 push the first steel ball 471 to move, so that the first steel ball 471 overcomes the elastic force of the first spring 472 and no longer blocks the first through hole 4411, the hydraulic oil in the rodless chamber 46 directly enters the rod chamber 45 through the first through hole 4411, and the piston rod 43 drives the wood splitting axe 3 to reset smoothly and rapidly.

The above shows and describes the basic principles, main features and advantages of the present technical solution. It should be understood by those skilled in the industry that the present technical solution is not limited to the above embodiment. The description in the above embodiment and specification are only used for explaining the principles of the present technical solution. Without departing from the spirit and scope of the present technical solution, the present technical solution may have various variations and improvements, which fall within the protection scope of the present technical solution. The required protection scope of the present technical solution is defined by the attached claims and their equivalents.

It should be noted that the structure, proportion, size, etc. plotted in the drawings of this specification are only used to match the contents disclosed in the specification. They are used for people familiar with this technology to understand and read, and are not used to restrict the limitations for the implementation of the present technical solution, so they have no substantial technical significance. Any modifications of the structure, changes in the proportional relationship, or adjustments of the size, without affecting the effects and purposes that can be achieved by the present technical solution, should still fall within the scope of the technical content disclosed by the present technical solution. At the same time, the terms such as “upper”, “lower”, “left”, “right”, “middle” and “a” quoted in this specification are only for the convenience of description, and are not used to limit the implementation scope of the present technical solution. The change or adjustment of their relationship without substantially changing the technical content should also be considered to fall within the implementation scope of the present technical solution.

It should also be noted that, when an element is referred to as being “fixed on” or “provided on” another element, it may be directly located on the other element or there may be an intermediate element at the same time. When an element is referred to as being “connected with” another element, it may be directly connected with the other element or may be indirectly connected with another element through an intermediate element.

In addition, the descriptions of “first”, “second”, etc. in the present application are only used for descriptive purposes and cannot be understood as indicating or implying their relative importance or implicitly indicating the number of the indicated technical features. Therefore, the features defined as “first” and “second” may explicitly or implicitly include at least one of the features. Furthermore, the technical solutions of the various embodiment can be combined with each other, but they must be based on the fact that the ordinary technicians in this field can implement them. When the combination of technical solutions is contradictory or cannot be implemented, it should be deemed that such combination of technical solutions does not exist and is not within the scope of protection required by the present application.

What is claimed is:

1. A two-way quick cylinder, comprising:
a hydraulic oil cylinder body;
a large piston, which is slidably provided in the said hydraulic oil cylinder body and divides the inner chamber of the said hydraulic oil cylinder body into a rod chamber and a rodless chamber;
a piston rod, which is telescopically installed on the said hydraulic oil cylinder body, and the end of the said piston rod extends into the said rod chamber to be connected with the said large piston;
a hydraulically controlled one-way valve, which is installed on the said large piston to be used for communicating the said rod chamber and the said rodless chamber; and
when hydraulic oil enters the rodless chamber from the oil pump and drives the large piston to move, the oil pressure in the said rod chamber increases and the hydraulically controlled one-way valve is enabled to open, so that the hydraulic oil in the rod chamber enters the rodless chamber through the hydraulically controlled one-way valve and pushes the large piston to move.

2. The two-way quick cylinder of claim 1, wherein further comprises a quick reset unit, which is used to control the hydraulic oil in the rodless chamber to return to the rod chamber through the said hydraulically controlled one-way valve; and the quick reset unit, which comprises a hollow perforated inner pull rod, a small piston, a push rod seat and a push rod assembly;
the said piston rod is hollow;
one end of the hollow perforated inner pull rod is connected to the cylinder rear cover of the said hydraulic oil cylinder body, the other end passes through the said large piston and extends into the inner chamber of the said piston rod, and the hollow perforated inner pull rod is slidably connected to the large piston;
the said large piston is provided with a mounting chamber, and a push rod seat and a push rod assembly are provided in the mounting chamber; an oil passage communicating the said rod chamber and the hydraulically controlled one-way valve is formed in the middle of the push rod seat and the push rod assembly; the portion of the said push rod seat adjacent to the said hydraulically controlled one-way valve is a second guide portion II, and an auxiliary piston chamber is formed between the peripheral side of the guide portion II and the side wall of the mounting chamber, one end of the said push rod assembly is provided in the auxiliary piston chamber to form a piston portion, and the other end of the push rod assembly faces the said hydraulically controlled one-way valve;
the said small piston is connected to one end of the said hollow perforated inner pull rod, and the peripheral side of the said small piston is slidably connected to the inner wall of the said piston rod, and the said small piston divides the inner chamber of the said piston rod into a reset area and an avoidance area;
the said reset area is communicated to the oil circuit inside the said hollow perforated inner pull rod;
a control oil hole is provided on the said piston rod, the control oil hole is communicated to the said reset area, and the control oil hole makes the oil circuit between the said reset area and the said auxiliary piston chamber communicated; and when hydraulic oil in the reset area enters the auxiliary piston chamber, the push rod assembly drives the said hydraulically controlled one-way valve to open.

3. The two-way quick cylinder of claim 2, wherein a control unit is provided on the said hydraulic oil cylinder body, and the said control unit comprises a control valve; and the said control valve is in plate connection with the cylinder front cover of the said hydraulic oil cylinder body, the said control valve and the said cylinder rear cover are communicated through two connecting oil pipes, and the said control valve is used to control the said connecting oil pipes to supply oil to the said rodless chamber or the said reset area respectively.

4. The two-way quick cylinder of claim 1, wherein the said hydraulically controlled one-way valve comprises a first steel ball and a first spring;
a first through hole is opened on the said large piston, and the said rodless chamber passes through the said first through hole and communicates with the said rod chamber; and
one end of the said first spring is connected to the said large piston, and the other end is connected to the said first steel ball, making the said first steel ball block the said first through hole.

5. The two-way quick cylinder of claim 3, wherein:
a hydraulically controlled switching valve is integrated on the said control unit or the cylinder front cover, and when the hydraulic oil pressure in the said rodless chamber reaches a set value P, the said hydraulically controlled switching valve makes the rod chamber communicate with the oil return line;
a second through hole is provided on the said oil cylinder front cover, and the said rod chamber and the oil return line are communicated through the said second through hole;
the said control valve is connected to an oil circuit board, the said oil circuit board is mounted on the said cylinder front cover, a third through hole is provided on the said oil circuit board, and the oil return line and the second through hole are communicated through the third through hole;
the said hydraulically controlled switching valve comprises a thrust controlled push rod valve core, a second steel ball and a second spring; and one end of the said second spring is connected to the said oil circuit board, and the other end is connected to the said second steel ball, making the said second steel ball block the said third through hole; and
the said thrust controlled push rod valve core is slidably connected in the said oil circuit board, and the said push rod of the thrust controlled push rod valve core can pass through the third through hole to abut against the said second steel ball.

6. The two-way quick cylinder of claim 5, wherein:
the said hydraulic oil cylinder body comprises a cylinder body, a cylinder front cover installed on the cylinder body, a cover and a control valve in plate connection with the cylinder front cover; and
the said hydraulic cylinder body comprises a cylinder steel pipe and a cylinder rear cover, wherein the cylinder steel pipe, the cylinder rear cover and two connecting oil pipes are welded into a whole, the said cylinder rear cover is provided with an ejection oil hole communicating the rodless chamber and the control valve as well as a retraction oil hole communicating the hollow perforated inner pull rod and the control valve, and the two connecting oil pipes are inserted into the said control valve.

7. A wood splitter, comprising:
a frame, a baffle, a wood splitting axe, the two-way quick cylinder of claim 1 and a power unit;
the two-way quick cylinder is installed on the said frame, the baffle is installed on the said frame, the wood splitting axe is installed on the driving end of the two-way quick cylinder, and a working space for placing wood is formed among the frame, the baffle and the wood splitting axe; and the power unit is installed on the said frame to provide power for the two-way quick cylinder;
the frame is provided with a main beam, the base of the main beam is made of H-shaped steel, the tail end of the said main beam is bent and warped upwards, the tail end of the said main beam is inlaid and welded with a tail plate, reinforcing plates are provided on both sides of the tail plate, and the end of the two-way quick cylinder is installed on the reinforcing plates and the tail plate; and
reinforcing rib plates are provided on both sides of the said main beam, the upper ends of the reinforcing rib plates are bent and placed above the main beam to form guide rails for the wood splitting axe to slide; and guide plates are provided obliquely on both sides of the main beam, the said guide plates are located between the guide rails and the baffle, the upper part of the guide plate is bent, and the guide plates are used for guiding the wood chips to fall from the upper end of the main beam.

8. The wood splitter of claim 7, wherein:
the said power unit comprises an engine, an adapter plate, an oil pump and an oil tank; and the oil pump is provided in the oil tank, and is integrated with the engine through the adapter plate;
the said engine is connected to the said frame;
one side of the said adapter plate is connected to the said engine, and the other side is connected to the said oil pump;
the said oil tank is provided on the outer peripheral side of the said oil pump in a housing manner, and the said oil tank is connected to the said adapter plate; and
the said oil pump is connected to the said control unit through the said adapter plate and the oil pipeline successively, and delivers hydraulic oil to the reset area or the said rodless chamber respectively through the control unit.

9. The wood splitter of claim 7, wherein:
the said wood splitting axe is in an S-type eagle head shape, It comprises a force-bearing main body, a guide portion I and a blade portion; the guide portion I is located at the lower side of the force-bearing main body and the blade portion and is provided horizontally, the force-bearing main body is provided vertically above the guide portion I, the blade portion is provided on the side of the force-bearing main body away from the two-way quick cylinder, and the front end of the blade portion is provided with a cutting edge;
the said cutting edge is S-shaped, and a fixing portion is provided on the upper side thereof, and the fixing portion is used to fix the wood; and a knife edge portion is provided on the lower half of the cutting edge in a protruding manner, and the knife edge portion is used to split the wood;
the said fixing portion is farther away from the said two-way quick cylinder than the knife edge portion; an arc-shaped concave first blade portion is formed between the fixing portion and the knife edge portion; and a second blade portion inclined inwardly is formed on the lower side of the knife edge portion.

10. The wood splitter of claim 7, wherein:
a plurality of reinforcing ribs are provided on the side of the said baffle away from the wood splitting axe, the plurality of reinforcing ribs are connected end to end to form reinforcing rings by welding, and the inner walls of the reinforcing rings are connected by welding through the reinforcing ribs.
